(19) United States
(12) Patent Application Publication
(10) Pub. No.: US 2026/0277467 A1
(43) Pub. Date: Sep. 17, 2026

(54) SYSTEMS, METHODS, AND DEVICES FOR MEMORY CONFIGURATION USING MEMORY ACCESS SWITCH

(71) Applicant: Samsung Electronics Co., Ltd., Suwon-si (KR)

(72) Inventors: Heekwon PARK, San Jose, CA (US); Yang Seok KI, Palo Alto, CA (US)

(21) Appl. No.: 19/417,313

(22) Filed: Dec. 11, 2025

Related U.S. Application Data
(60) Provisional application No. 63/771,609, filed on Mar. 13, 2025.

(51) Int. Cl. G06F 3/06

(52) U.S. Cl. CPC G06F 3/0655; G06F 3/0604; G06F 3/0679

(57) ABSTRACT

An apparatus may include a memory device including a memory, a memory access interface configured to access the memory using a memory access protocol, and at least one control circuit configured to send a notification based on a throughput of the memory device. A system may include a first memory device, a second memory device, a host, a switch connected to the first memory device, the second memory device, and the third memory device, and at least one control circuit configured to allocate a portion of the second memory device to the host based on a throughput of the first memory device. A method may include detecting, at a first memory device, a throughput of the first memory device, sending, from the first memory device, using a memory access interface, based on the detecting, a notification, and assigning, to a host, based on the notification, a second memory device.

### REFERENCE TO RELATED APPLICATION

This application claims priority to, and the benefit of, U.S. Provisional Patent Application Ser. No. 63/771,609 filed Mar. 13, 2025 which is incorporated by reference.

### TECHNICAL FIELD

This disclosure relates generally to memory systems, and more specifically to systems, methods, and devices for memory configuration using memory access switches.

### BACKGROUND

Some memory systems may include a memory access switch that may selectively connect one or more hosts to one or more memory devices. A memory access switch may enable a host to access a pool of shared memory located across multiple memory devices.

The above information disclosed in this Background section is only for enhancement of understanding of the background of the inventive principles and therefore it may contain information that does not constitute prior art.

### SUMMARY

An apparatus may include a memory device including a memory, a memory access interface configured to access the memory using a memory access protocol, and at least one control circuit configured to send a notification based on a throughput of the memory device. The at least one control circuit may be configured to determine the throughput based on one or more memory access operations. The at least one control circuit may be configured to determine the throughput based on one or more memory access operations associated with an epoch. The at least one control circuit may be configured to determine the throughput based on one or more memory access operations for a first logical device, and one or more memory access operations for a second logical device. The at least one control circuit may be configured to send the notification using an interrupt. The at least one control circuit may be configured to receive a parameter, and determine the throughput based on the parameter and one or more memory access operations. The throughput of the memory device comprises a saturation condition.

A system may include a first memory device having a first memory and a first memory access interface, second memory device having a second a memory and a second memory access interface, a host having a third memory access interface, a switch connected to the first memory access interface, the second memory access interface, and the third memory access interface, and at least one control circuit configured to allocate a portion of the second memory to the host based on a throughput of the first memory device. The first memory access interface, the second memory access interface, and the third memory access interface may be configured to use a memory access protocol. The first memory device may be configured to send, based on the throughput of the first memory device, a notification. The first memory device may be configured to send, using an interrupt, based on the throughput of the first memory device, a notification. The first memory device may be configured to send, to a host, based on the throughput of the first memory device, a notification, and the host may be configured to request, based on the notification, a logical device. The host may be configured to send, based on the throughput of the first memory device, to a fabric manager, a request for to assign a logical device, and the fabric manager may be configured to send, based on the request, to the host, an assignment of the logical device. The at least one control circuit may be configured to send, to the host, based on the throughput of the first memory device, an assignment of a logical device, and the second memory device may be configured to attach, based on the assignment, to the host. The second memory device may be configured to perform at least one operation comprising attaching, based on the throughput of the first memory device, to the host, and the host may be configured to allocate, based on the attaching, memory from the second memory device. The first memory device may be configured to receive a parameter associated with the throughput of the first memory device, and determine, based on the parameter, the throughput of the first memory device.

A method may include detecting, at a first memory device, a throughput of the first memory device, sending, from the first memory device, using a memory access interface, based on the detecting, a notification, and assigning, to a host, based on the notification, a second memory device. The method may further include attaching, to the host, based on the notification, using a switch, the second memory device. The method may further include allocating, by the host, based on the assigning, memory from the second memory device. The method may further include selecting, based on the notification, the second memory device.

### BRIEF DESCRIPTION OF THE DRAWINGS

The figures are not necessarily drawn to scale and elements of similar structures or functions may generally be represented by like reference numerals or portions thereof for illustrative purposes throughout the figures. The figures are only intended to facilitate the description of the various embodiments described herein. The figures do not describe every aspect of the teachings disclosed herein and do not limit the scope of the claims. To prevent the drawings from becoming obscured, not all of the components, connections, and the like may be shown, and not all of the components may have reference numbers. However, patterns of component configurations may be readily apparent from the drawings. The accompanying drawings, together with the specification, illustrate example embodiments of the present disclosure, and, together with the description, serve to explain the principles of the present disclosure.

FIG. 1A illustrates an embodiment of a memory system including a host, a memory access switch, and a memory device with a first utilization in accordance with example embodiments of the disclosure.

FIG. 1B illustrates the embodiment of the memory system illustrated in FIG. 1A in which the memory device has a second utilization in accordance with example embodiments of the disclosure.

FIG. 2A illustrates an embodiment of a memory system including a first host, a second host, a memory access switch, and a memory device with a first utilization in accordance with example embodiments of the disclosure.

FIG. 2B illustrates the embodiment of the memory system illustrated in FIG. 2A in which the memory device has a second utilization in accordance with example embodiments of the disclosure.

FIG. 3A illustrates an example embodiment of throughput detection and/or notification operations in a memory system including at least one host, a memory access switch, and at least one memory device in accordance with example embodiments of the disclosure.

FIG. 3B illustrates an example embodiment of a memory device attachment operation for the memory system illustrated in FIG. 3A in accordance with example embodiments of the disclosure.

FIG. 3C illustrates an example embodiment of a memory allocation operation for the memory system illustrated in FIG. 3B in accordance with example embodiments of the disclosure.

FIG. 4 illustrates an embodiment of a memory system that may assign one or more memory devices based on one or more throughputs of the one or more memory devices in accordance with example embodiments of the disclosure.

FIG. 5 illustrates an embodiment of a memory device having saturation detection and/or notification functionality in accordance with example embodiments of the disclosure.

FIG. 6 illustrates an example embodiment of a method and apparatus for monitoring, detecting, and/or sending a notification of, a throughput saturation condition for a memory device in accordance with example embodiments of the disclosure.

FIG. 7 illustrates an example embodiment of a method and apparatus for assigning and/or allocating a memory device and/or memory therein based on a saturation condition of a memory device in accordance with example embodiments of the disclosure.

FIG. 8 illustrates an embodiment of a method for assigning memory based on a throughput of a memory device in accordance with example embodiments of the disclosure.

FIG. 9 illustrates an embodiment of a memory access protocol stack in accordance with example embodiments of the disclosure.

### DETAILED DESCRIPTION

Some memory systems may include multiple memory devices arranged as a pool of shared memory using one or more memory access switches. The memory system may allocate memory from the pool based on the capacity utilization of individual memory devices. However, if a memory access interface of a memory device is saturated (e.g., operating at or near 100 percent throughput) while accessing less than all of its memory capacity, allocating additional memory capacity from the memory device may reduce the access performance of the memory device because the maximum throughput of the memory device may be spread across the additional memory capacity.

In some memory systems, the throughput of a memory device may be taken into consideration when allocating shared memory from a pool. For example, a first host may be aware that it is utilizing less than the maximum throughput of a memory device to access less than the entire capacity of the memory device. Thus, the first host may request an allocation of additional capacity of the memory device. However, the first host may not be aware that a second host may be using the remaining throughput of the memory device, and thus, the memory device may be saturated and unable to provide additional throughput to the first host.

Some aspects of the disclosure relate to techniques for dynamically allocating resources such as bandwidth, memory capacity, and/or the like, of one or more memory devices based on demand for resources across one or more memory devices, hosts, and/or the like. For example, in some embodiments, a fabric manager may monitor the throughput status (e.g., saturation status) of one or more memory devices. The fabric manager may use the throughput status, which may be based on operational information (e.g., real-time data), to assign one or more memory devices (and/or one or more logical devices therein) that may have available bandwidth and/or memory capacity to a host. Depending on the implementation details, this may spread throughput across memory devices, thereby increasing or maximizing overall memory access throughput across some or all memory devices.

In some embodiments, a fabric manager may assign one or more memory devices (and/or one or more logical devices therein) to a host based on a request from the host to assign a new memory device. In some embodiments, the fabric manager may send a request to the one or more assigned memory devices to attach the memory device(s) and/or logical device(s) therein, to the host. Based on the attachment request, the one or more assigned memory devices may attach the memory device(s) and/or logical device(s) therein, to the host. The host may allocate one or more portions (e.g., one or more pages) of memory from the attached memory device(s) and/or logical device(s) therein.

Some additional aspects of the disclosure relate to techniques for monitoring the throughput status (e.g., saturation status) of one or more memory devices. For example, in some embodiments, one or more memory devices may implement a saturation tracking method by maintaining and/or analyzing one or more cumulative counts of read and/or write requests. One or more counts may be accumulated for each logical device, a group of logical devices, and/or the like. Additionally, or alternatively, one or more counts may be accumulated on an epoch basis (e.g., for a fixed or variable length of time). A saturation status may be determined, for example, based on a sum of throughputs for one or more logical devices in a memory device reaching a threshold (e.g., a maximum bandwidth for a memory access interface). Depending on the implementation details, monitoring throughput status at a memory device based on a per logical device and/or epoch basis may provide relatively precise resource monitoring with relatively low overhead.

In some embodiments, upon detecting a throughput (e.g., saturation) status, a memory device may send a notification of the throughput status to one or more hosts, fabric managers, and/or the like. A memory device may send a notification, for example, by broadcasting the notification (e.g., using an interrupt) to one or more hosts, fabric managers, and/or the like. In some embodiments, based on receiving a notification of a throughput status of an attached memory device, a host may send a request to a fabric manager to assign a new memory device. In some embodiments, the request may include information about a throughput (e.g., saturation) status of one or more memory devices from which the host may have received a notification.

This disclosure encompasses numerous aspects relating to assigning, attaching, and/or allocating one or more memory devices, logical devices therein, and/or memory therein, based on throughput status, memory utilization, and/or the like, of one or more memory devices. The aspects disclosed herein may have independent utility and may be embodied individually, and not every embodiment may utilize every aspect. Moreover, the aspects may also be embodied in various combinations, some of which may amplify some benefits of the individual aspects in a synergistic manner.

For purposes of illustration, some embodiments may be described in the context of some specific implementation details such as specific interfaces, protocols, and/or the like. However, the aspects of the disclosure are not limited to these or any other implementation details.

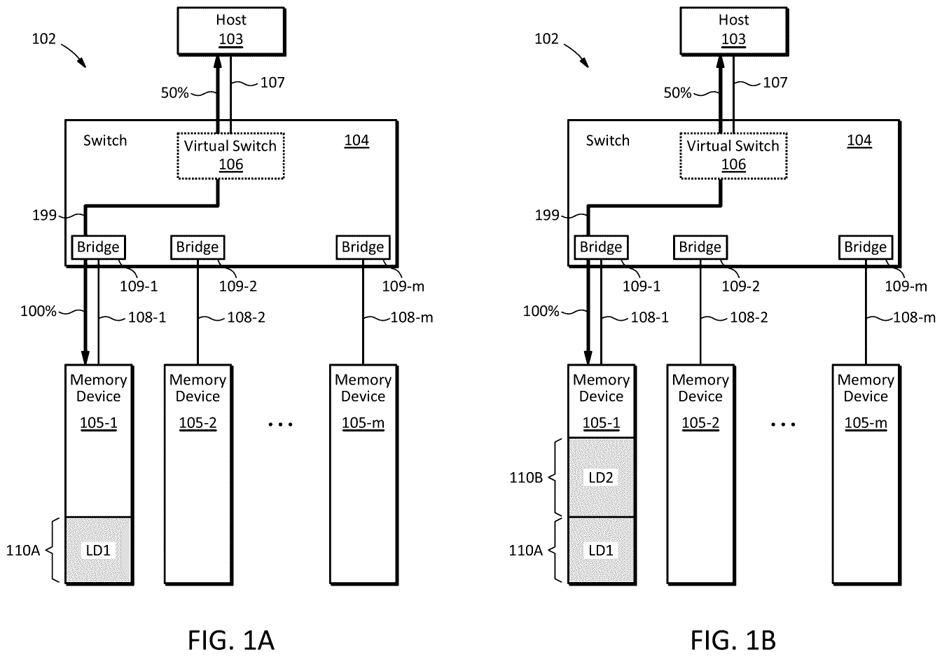

In some example embodiments described here, reference indicators having a base portion and a suffix portion may be referred to collectively and/or individually by the base portion. For example, the one or more memory devices 105-1, 105-2, . . . 105-m illustrated in FIG. 1A may be referred to collectively and/or individually as 105.

Multiple figures having the same numbers with different letter suffixes may be referred to collectively and/or individually by the number. For example, FIG. 1A and FIG. 1B may be referred to collectively and/or individually as FIG. 1.

FIG. 1A illustrates an embodiment of a memory system including a host, a memory access switch, and a memory device with a first utilization in accordance with example embodiments of the disclosure. FIG. 1B illustrates the embodiment of the memory system illustrated in FIG. 1A in which the memory device has a second utilization in accordance with example embodiments of the disclosure.

Referring to FIG. 1A, the memory system 102 may include one or more hosts 103, a memory access switch 104 (which may also be referred to as a switch, a memory switch, a protocol switch, a memory access protocol switch, a memory interface switch, and/or a memory access interface switch), and/or one or more memory devices 105-1, 105-2, . . . 105-m (which may also be referred to as devices). Switch 104 may include at least one virtual switch (VS) 106 (which may also be referred to as a virtual memory access protocol switch and/or a virtual memory access interface switch). In some embodiments, a virtual switch 106 may include, and/or be referred to as, pooling logic.

In some embodiments, a virtual switch may include one or more bridges (e.g., one or more virtual bridges) that may bind one or more apparatus to the virtual switch and, therefore, to each other. For example, virtual switch 106 illustrated in FIG. 1A may include a virtual bridge that may be configurable (e.g., dynamically) to bind (e.g., attach) one or more hosts 103 to virtual switch 106. In some embodiments, virtual switch 106 may also include m bridges (e.g., virtual bridges), that may be configurable (e.g., dynamically) to bind (e.g., attach) memory devices 105-1, . . . 105-m, respectively, to virtual switch 106. In some embodiments, virtual switch 106 may include a memory decoding mechanism that may enable virtual switch 106 to route a memory access request from one or more hosts 103 to one or more target memory devices 105.

Depending on the implementation details, a virtual switch may enable resources such as memory at one or more memory devices 105 to be partitioned and/or isolated between hosts 103 in a system 102 that may have more than one host 103. For example, at least one (e.g., each) host 103 may see a separate virtual switch 106 that may include one or more bridges for one or more corresponding memory devices 105 assigned to a host 103. Thus, in some embodiments, one or more virtual switches 106 may support multi-host connections and/or enable pooling of memory at one or more memory devices 105.

Host 103 may be connected to switch 104 and/or virtual switch 106 using a communication link 107. One or more memory devices 105-1, 105-2, . . . 105-m may be connected to switch 104 and/or virtual switch 106 using one or more communication links 108-1, 108-2, . . . 108-m. Switch 104 may also include one or more interconnect bridges 109-1, 109-2, . . . 109-m that may connect one or more interfaces, controllers, and/or the like, for communication links 108-1, 108-2, . . . 108-m, respectively.

Some or all of the memory capacity of one or more memory devices 105-1, 105-2, . . . 105-m may be configured as a pool of shared memory that may be accessed by host 103 using switch 106. Memory within a memory device may be allocated in the form of a logical device (LD). Memory system 102 may allocate memory from the pool based on the capacity utilization of one or more individual memory devices 105-1, 105-2, . . . 105-m. For example, a first portion 110A (e.g., 30 percent) of the capacity of memory device 105-1 may initially be allocated to host 103 and implemented as a first logical device LD1.

A data path between host 103 and memory device 105-1 may be indicated by an arrow 199. A portion of the data path indicated by arrow 199 through communication link 107 may use 50 percent of the bandwidth of communication link 107 (e.g., 32 GB/s of a 64 GB/s link). A portion of the data path indicated by arrow 199 through communication link 108-1 may use 100 percent of the bandwidth of communication link 108-1 (e.g., 32 GB/s of a 32 GB/s link).

In this example, host 103 may use the entire bandwidth of link 108-1 to access first portion 110A. Thus, link 108-1 may be referred to as being saturated. (Additionally, or alternatively, memory device 105-1 may be referred to as being saturated, the throughput of link 108-1 may be referred to as being saturated, a downstream port of switch 104 and/or virtual switch 106 may be referred to as being saturated, and/or an upstream port of memory device 105-1 may be referred to as being saturated.)

Referring to FIG. 1B, if host 103 requests additional memory capacity, system 102 may allocate a second portion 110B (e.g., 40 percent) of the memory capacity of the same memory device 105-1 to host 103 because 70 percent of the capacity of memory device 105-1 may be available (e.g., unallocated). Second portion 110B may be implemented as a second logical device LD2.

However, because link 108-1 may be saturated (e.g., operating at 100 percent or maximum throughput) while accessing the original portion 110A, allocating another portion 110B of the capacity of memory device 105-1 may reduce the access performance of memory device 105-1 because the maximum throughput of communication link 108-1 may be spread across 70 percent (110A+110B) instead of the original 30 percent (110A) of the capacity of memory device 105-1. Thus, allocating capacity based on utilization (e.g., available capacity) of a memory device without considering the throughput of a host, a virtual switch, a downstream port, a communication link, the memory device, and/or the like, may cause utilization of memory device 105-1 to increase while the throughput of memory device 105-1 may remain flat. Depending on the implementation details, this may be described as utilization and throughput not being correlated (e.g., not directly correlated).

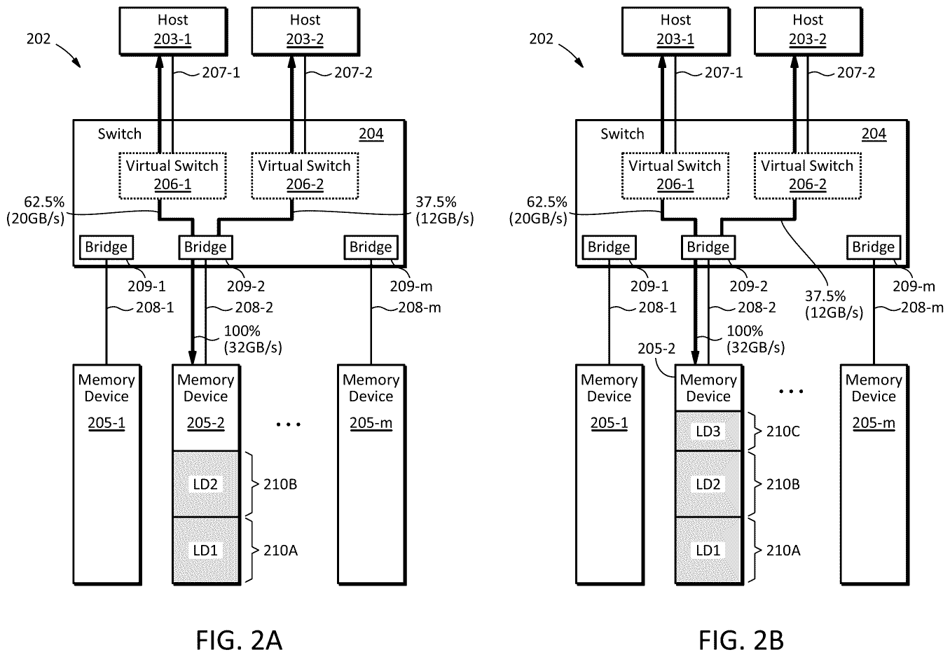

FIG. 2A illustrates an embodiment of a memory system including a first host, a second host, a memory access switch, and a memory device with a first utilization in accordance with example embodiments of the disclosure. FIG. 2B illustrates the embodiment of the memory system illustrated in FIG. 2A in which the memory device has a second utilization in accordance with example embodiments of the disclosure.

The embodiment illustrated in FIG. 2 may include one or more elements that may, in some aspects, be similar to the embodiments illustrated in FIG. 1 in which similar elements may be indicated by reference numbers ending in, and/or containing, the same digits, letters, and/or the like. For example, memory system 202 illustrated in FIG. 2 may include a switch 204, a first host 203-1, a first virtual switch 206-1, one or more interconnect bridges 209-1, 209-2, . . . 209-m, and/or one or more memory devices 205-1, 205-2, . . . 205-m connected to one or more corresponding interconnect bridges 209-1, 209-2, . . . 209-m using one or more corresponding communication links 208-1, 208-2, . . . 208-m.

However, the system 202 illustrated in FIG. 2 may include a second host 203-2 and/or a second virtual switch 206-2. Moreover, in system 202, the throughput of a host, a communication line between the host and a switch and/or a virtual switch may be taken into consideration when allocating shared memory from a pool.

Referring to FIG. 2A, a first portion 210A (e.g., 30 percent) of the capacity of memory device 205-2 may be implemented as a first logical device LD1 and assigned to first host 203-1. A second portion 210B (e.g., 30 percent) of the capacity of memory device 205-2 may be implemented as a second logical device LD2 and assigned to second host 203-2. Thus, hosts 203-1 and 203-2 may share the capacity of memory device 205-2.

In this embodiment, system software and/or an operating system (OS) for one or more of hosts 203-1 and/or 203-2 may track throughputs of one or more of hosts 203-1 and/or 203-2, switch 204, one or more of virtual switches 206-1 and/or 206-2, one or more memory devices 205-1, 205-2, . . . 205-m, and/or the like. In some embodiments, one or more performance monitoring units may enable performance monitoring and/or analysis for one or more logical devices (e.g., each logical device). Thus, a host 203 may track the throughput of one or more logical devices attached to the host, from the perspective of the host. Moreover, a host 203 may consider the throughput of one or more logical devices attached to the host when requesting additional memory capacity from one or more memory devices 205.

However, if multiple hosts 203 share the memory capacity of a memory device 205, saturation of the shared memory device 205 may not be detected by one or more of hosts 203.

For example, referring to FIG. 2A, host 203-1 may use 62.5 percent of the bandwidth of communication link 208-2 (e.g., 20 GB/s of a 32 GB/s link) to access LD1 which may include 30 percent of the capacity of memory device 205-2. Thus, host 203-1 may request an additional 18 percent of the capacity of memory device 205-2 which host 203-1 may assume may be accessed using the remaining 37.5 percent (e.g., 12 GB/s) of the bandwidth of communication link 208-2.

However, host 203-1 may be unaware that host 203-2 may be using the remaining 37.5 percent of the bandwidth of communication link 208-2 (e.g., 12 GB/s of a 32 GB/s link) to access LD2 in memory device 205-2, and therefore, 203-1 may be limited to using 62.5 percent of the bandwidth of communication link 208-2. Thus, if a third portion 210C (e.g., 18 percent) of the capacity of memory device 205-2 is allocated to host 203-1 as LD3 as illustrated in FIG. 2B, the memory access performance of host 203-1 may decrease because host 203-1 may still only be able to use 62.5 percent of the bandwidth of communication link 208-2 to access an increased amount of memory (e.g., 30 percent in LD1 plus 18 percent in LD3).

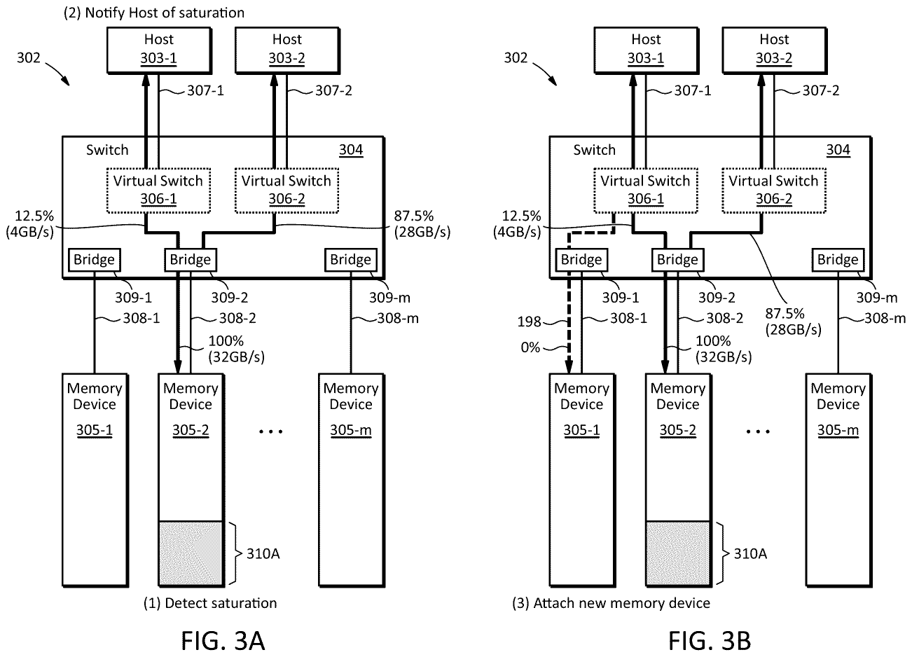

FIG. 3A illustrates an example embodiment of throughput detection and/or notification operations in a memory system including at least one host, a memory access switch, and at least one memory device in accordance with example embodiments of the disclosure. FIG. 3B illustrates an example embodiment of a memory device attachment operation for the memory system illustrated in FIG. 3A in accordance with example embodiments of the disclosure. FIG. 3C illustrates an example embodiment of a memory allocation operation for the memory system illustrated in FIG. 3B in accordance with example embodiments of the disclosure.

Referring to FIG. 3A, the memory system 302 may include one or more elements that may, in some aspects, be similar to the embodiments illustrated in FIG. 1 and/or FIG. 2 in which similar elements may be indicated by reference numbers ending in, and/or containing, the same digits, letters, and/or the like. For example, memory system 302 illustrated in FIG. 3 may include a switch 304, first and/or second hosts 303-1 and/or 303-2 connected to switch 304 using one or more corresponding communication links 307-1, 307-2, . . . , respectively, first and/or second virtual switches 306-1 and/or 306-2, and/or one or more memory devices 305-1, 305-2, . . . 305-m connected to switch 304 using one or more corresponding communication links 308-1, 308-2, . . . 308-m, respectively, and/or one or more bridges 309-1, 309-2, . . . 309-m, respectively. However, in memory system 302, one or more memory devices 305, memory capacity of one or more memory devices 305, and/or logical devices configured within one or more memory devices 305, may be assigned, attached, allocated, and/or the like, based on the throughput of one or more memory devices 305.

For purposes of illustration, memory devices 305-1, 305-2, . . . 305-m may be assumed to have a maximum bandwidth of 32 GB/s each, but the aspects of the disclosure are not limited to these or any other implementation details.

Referring to FIG. 3A, host 303-1 and host 303-2 may be configured to utilize a combined 30 percent portion 310A of the capacity of memory device 305-2. Host 303-1 may access portion 310A at a throughput of 4 GB/s (e.g., 12.5 percent of the bandwidth of memory device 305-2).

Host 303-2 may access portion 310A at a throughput of 28 GB/s (e.g., 87.5 percent of the bandwidth of memory device 305-2). Thus, the total throughput of memory device 305-2 may be saturated at 32 GB/s (e.g., 100 percent of its maximum bandwidth).

At operation (1), memory device 305-2 may detect a saturation condition of memory device 305-2. For example, memory device 305-2 may determine that the total throughput of memory device 305-2 may exceed a threshold value that may be expressed, for example, as a percentage of the maximum bandwidth of memory device 305-2.

At operation (2), memory device 305-2 may send a notification to one or more hosts 303 and/or one or more other components of memory system 302 indicating the saturation condition of memory device 305-2. The notification may be sent, for example, using an interrupt mechanism and/or any other communication mechanism using one or more communication links 307, one or more sideband connections (e.g., management connections), and/or the like.

Host 303-1 may determine that it needs additional memory capacity. Because only 30 percent of the capacity of memory device 305-2 may be utilized, it may be possible to allocate additional capacity (e.g., a 40 percent portion) of memory device 305-2 to host 303-1. However, because the throughput of memory device 305-2 may be saturated, allocating additional memory capacity from memory device 305-2 to host 303-1 may cause a decrease in memory access performance. Thus, based on receiving the notification indicating the saturation condition of memory device 305-2, host 303-1 may request an assignment by memory system 302 of an additional (e.g., unsaturated) memory device 305 that may be attached to host 303-1.

Referring to FIG. 3B, at operation (3), a second memory device 305-1 may be attached to host 303-1. For example, memory system 302 may select and assign memory device 305-1 to host 303-1 and request that memory device 305-1 attach itself to host 303-1. Memory device 305-1, which may initially have zero percent throughput and/or zero percent utilization, may attach itself to host 303-1 using, for example, communication link 308-1 as shown by arrow 198.

Referring to FIG. 3C, at operation (4) host 303-1 may allocate a 40 percent portion 310B of the capacity of memory device 305-1. Portion 310B may be implemented, for example, as one or more pages of memory, one or more logical devices, and/or the like. Host 303-1 may access portion 310B of memory device, for example, at a throughput of 18 GB/s (e.g., 56.25 percent of the bandwidth of memory device 305-1) using communication link 308-1. Thus, communication link 307-1 between host 303-1 and virtual switch 306-1 may operate at 22 GB/s to accommodate the 4 GB/s throughput with memory device 305-2 and the 18 GB/s throughput with memory device 305-1.

Depending on the implementation details, assigning, attaching, allocating, and/or the like, one or more memory devices 305 and/or capacity thereof, to a host 303 based on throughput information (e.g., a saturation condition) of one or more memory devices 305 may improve the memory access performance of a host 303, for example, by enabling a host 303 to avoid allocating memory capacity at saturated memory devices, thereby increasing the overall memory throughput for the host 303 while increasing memory capacity allocated to the host 303.

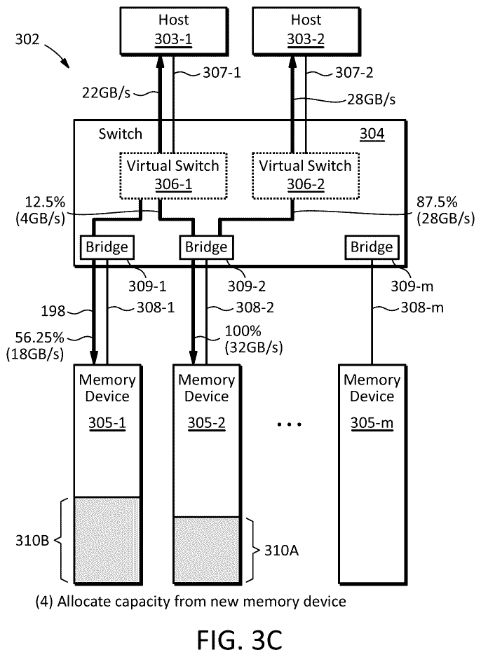

FIG. 4 illustrates an embodiment of a memory system that may assign one or more memory devices based on one or more throughputs of the one or more memory devices in accordance with example embodiments of the disclosure. The memory system 402 may be implemented with, and/or be used to implement, any of the memory systems disclosed herein, including those illustrated with respect to FIG. 1, FIG. 2, FIG. 3, and/or any other figures. Memory system 402 may include one or more elements that may, in some aspects, be similar to the embodiments illustrated in other figures in which similar elements may be indicated by reference numbers ending in, and/or containing, the same digits, letters, and/or the like.

For purposes of illustrating aspects of the disclosure, memory system 402 may be illustrated with a host 403, a switch 404, and/or memory devices 405-1 and/or 405-2, but any numbers of hosts 403, switches 404, and/or memory devices 405 may be included in various embodiments.

Host 403 may include a memory access interface 412 that may communicate with a memory access interface 413 in switch 404 through a communication link 407 using one or more memory access protocols. Switch 404 may include memory access interfaces 414-1 and/or 414-2 that may communicate with a memory access interfaces 415-1 and/or 415-2 in memory devices 405-1 and/or 405-2, respectively, through communication links 408-1 and/or 408-2, respectively, using one or more memory access protocols.

Some or all of interface 412, interface 413, and/or communication link 407 may be referred to and/or characterized as an upstream port (USP), for example, from the perspective of switch 404. Some or all of interfaces 414-1 and/or 414-2, corresponding interfaces 415-1 and/or 415-2, and/or corresponding communication links 408-1 and/or 408-2 may be referred to and/or characterized as downstream ports (DSPs), for example, from the perspective of switch 404.

Memory system 402 may also include one or more control circuits 417 that may control some or all of the functionality (e.g., logic) relating to assigning, attaching, and/or allocating one or more memory devices, logical devices therein, and/or memory therein, based on throughput status, memory utilization, and/or the like, of one or more memory devices in accordance with example embodiments of the disclosure. For example, the one or more control circuits 417 may perform any number of the following functions: monitoring the throughputs of one or more memory devices 405; detect saturation conditions of one or more memory devices 405; sending a notification of a saturation condition to one or more hosts 403 and/or one or more other components of memory system 402; selecting one or more memory devices 405 to assign to one or more hosts 403; attaching one or more memory devices 405 to one or more hosts 403; allocating memory in one or more memory devices 405 to one or more hosts 403; and/or the like.

The one or more control circuits 417 may be implemented partially or entirely in any component or combination of components in memory system 402. For example, in some embodiments, the one or more control circuits 417 may be implemented in a separate component as illustrated in FIG. 4. In other embodiments, some of the functionality (e.g., logic) of the one or more control circuits 417 may be spread, at least partially, among other components. For example, in some embodiments, functionality to monitor throughput, detect saturation, send notifications of saturation, and/or attach to a host 403 may be located in one or more memory devices 405, functionality to request assignment of a memory device 405 and/or allocate memory in a memory device 405 may be located at one or more hosts 403, and functionality to assign a memory device 405 and/or request attachment of a memory device 405 may be located at a fabric manager which may be located, for example, at a switch 404, one or more hosts 403, a separate component, and/or the like.

In some embodiments, some or all of the functionality (e.g., logic) of the one or more control circuits 417 may be implemented in, integrated with, coordinated with, and/or the like, other functionality in one or more other components of memory system 402. For example, although memory system 402 is not limited to any specific implementation details, in some embodiments, switch 404, one or more of memory devices 405, one or more of memory access interfaces 412, 413, 414, and/or 415 and/or communication links 407 and/or 408 may be implemented using Compute Express Link (CXL) components, interconnects, interfaces, protocols, and/or the like.

In embodiments implemented at least partially with CXL, the one or more control circuits 417 may be implemented in, integrated with, coordinated with, and/or the like, any number of the following: a performance monitoring circuit (e.g., a CXL Performance Monitoring Unit (CPMU)) which may be located at least partially at a host 403; a fabric manager which may be located at least partially at a host 403, a switch 404, and/or the like; a Component Command Interface (CCI) which may be implemented, for example, as mailbox CCI and/or Management Component Transport Protocol (MCTP) based CCI; a CXL controller which may be located, for example, in any component that communicates using CXL; and/or the like.

In embodiments implemented at least partially with CXL, one or more of memory devices 405 may be implemented with a CXL memory module (CMM) such as a CMM-D in which memory 416 may include primarily volatile memory such as dynamic random access memory (DRAM), a CMM-H in which memory 416 may include a hybrid configuration of volatile memory such as DRAM and nonvolatile memory such as flash memory, and/or the like. Additionally, or alternatively, in embodiments implemented at least partially with CXL, switch 404 may be implemented with a CXL switch, one or more virtual switches within switch 404 may be implemented with virtual CXL switches (VCSs), and/or one or more bridges 409 may be implemented with PCI-to-PCI bridges (PPBs).

Additionally, or alternatively, in embodiments implemented at least partially with CXL, one or more of memory access interfaces 412, 413, 414, and/or 415 and/or communication links 407 and/or 408 may be implemented with one or more CXL protocol stacks which may include one or more electrical and/or logical physical (PHY) layers that may implement one or more serial links, one or more CXL dynamic and/or static multiplexer (MUX) circuits, one or more link layers, and/or one or more transaction layers, any or all of which may implement one or more multiplexed (e.g., dynamically multiplexed) protocols such as CXL.io, CXL.cache, and/or CXL.mem. In some embodiments, one or more protocols such as CXL.cache, and/or CXL.mem may provide memory coherency.

Other examples of memory access interfaces, interconnects, protocols, and/or the like, that may be used to implement any of the functionally disclosed herein may include Peripheral Component Interconnect Express (PCIe), Nonvolatile Memory Express (NVMe), NVMe over Fabric (NVMe-oF), Gen-Z, Open Coherent Accelerator Processor Interface (OpenCAPI), Cache Coherent Interconnect for Accelerators (CCIX), Direct Memory Access (DMA), Remote DMA (RDMA), RDMA over Converged Ethernet (ROCE), and/or the like.

A host 403 may be implemented with any component or combination of components that may utilize one or more of memory devices 405 and/or memory therein which may be arranged, for example, as one or more pools of shared memory (e.g., implemented as logical devices). For example, a host may be implemented with one or more of a server, a storage node, a compute node, a central processing unit (CPU), a graphics processing unit (GPU), a data processing unit (DPU), a neural processing unit (NPU), a tensor processing unit (TPU), a workstation, a personal computer, a tablet computer, a smartphone, and/or the like, or multiples and/or combinations thereof.

A switch 404 may be implemented with any component or combination of components having any form factor such as an integrated circuit (IC) chip (e.g., a packaged semiconductor die), a semiconductor die, a multi-chip module, a multi-die module, a circuit board, an add-in card, a backplane, a midplane, or multiples and/or combinations thereof.

A memory device 405 may be implemented with any component or combination of components such as a CMM, a CXL solid state drive (SSD), a single inline memory module (SIMM), a dual inline memory module (DIMM), and/or the like, any of which may have any form factor such as a 3.5 inch, 2.5 inch, 1.8 inch, and/or the like, storage device (e.g., storage drive) form factor, M.2 device form factor, Enterprise and Data Center Standard Form Factor (EDSFF) (which may include, for example, E1.S, E1.L, E3.S, E3.L, E3.S 2T, E3.L 2T, and/or the like), add-in card (AIC) (e.g., a PCIe card (e.g., PCIe expansion card) form factor Next-generation Small Form Factor (NGSFF), NF1 form factor, and/or the like, or a combination thereof. Any memory device 405 disclosed herein may be connected to a system using one or more connectors such as Serial ATA (SATA), Small Computer Systems Interface (SCSI), Serial Attached SCSI (SAS), and/or M.2 connectors, EDSFF connectors (e.g., 1C, 2C, 4C, 4C+, and/or the like), U.2 connectors (which may also be referred to as SSD form factor (SSF) SFF-8639 connectors), U.3 connectors, PCIe connectors (e.g., card edge connectors), SIMM connectors, DIMM connectors, and/or the like.

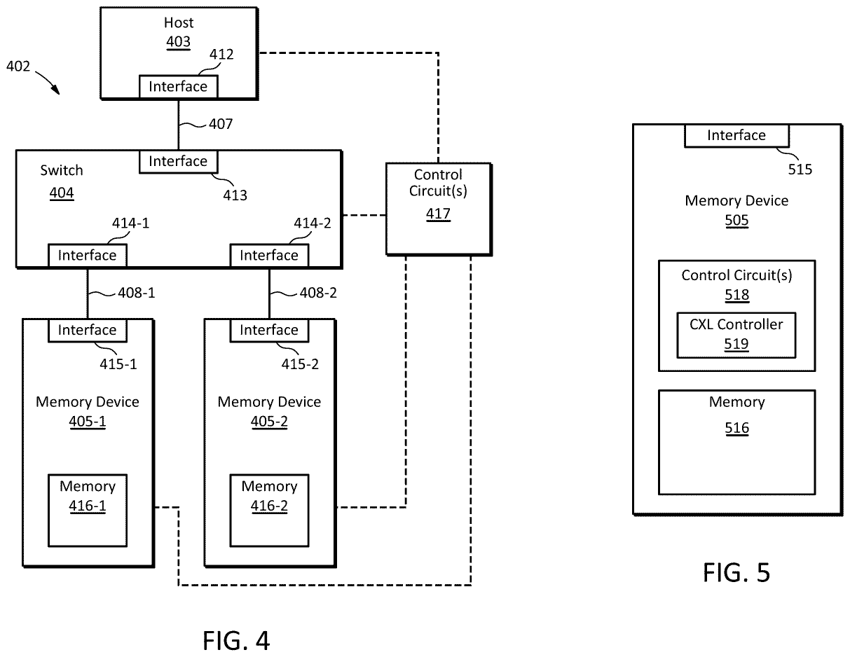

FIG. 5 illustrates an embodiment of a memory device having saturation detection and/or notification functionality in accordance with example embodiments of the disclosure. The memory device 505 may be implemented with, or be used to implement, any of the memory devices, memory systems, and/or the like, disclosed herein. Memory device 505 may include one or more elements that may, in some aspects, be similar to the embodiments illustrated in other figures, for example, memory device 405 illustrated in FIG. 4 in which similar elements may be indicated by reference numbers ending in, and/or containing, the same digits, letters, and/or the like.

Referring to FIG. 5, memory device 505 may include a memory access interface 515, memory 516, and/or one or more control circuits 518. Memory 516 may be implemented, for example, with volatile memory such as DRAM, nonvolatile memory such as flash memory (e.g., not-AND (NAND) FLASH), and/or the like, or a combination thereof. Memory interface 515 may be implemented, for example, one or more communication stacks such as one or more CXL protocol stacks as described herein. The one or more control circuits 518 may be implemented at least partially, for example, with a device controller. In some embodiments, the one or more control circuits 518 may include a protocol controller such as a CXL controller 519, an NVMe controller, and/or the like. In an embodiment in which memory 516 may be implemented at least partially with nonvolatile memory such as flash memory, the one or more control circuits 518 may include a media translation layer such as a flash translation layer (FTL).

The one or more control circuits 518 may implement any functionality related to a memory device 505 disclosed herein. For example, the one or more control circuits 518 may implement a performance monitor to track throughput of memory device 505 and/or memory access interface 515, for example, on a per-logical-device basis. As another example, the one or more control circuits 518 may implement a saturation detector to determine when the throughput of memory device 505 and/or memory access interface 515 reaches a threshold (e.g., percentage of maximum bandwidth such as 100 percent or a lower percentage at which a memory device 505 may be effectively saturated because it may not be able to support enough additional throughput to efficiently access another logical device or other unit of memory). As further examples, the one or more control circuits 518 may implement functionality to: send notifications (e.g., to one or more hosts) of a saturation condition; receive and/or execute a request (e.g., from a fabric manager) to attach the memory device 505 and/or a logical device therein, to a host; receive and/or execute a request (e.g., from a host) to allocate a portion of memory 516 (e.g., one or more logical devices) to a host; and/or the like.

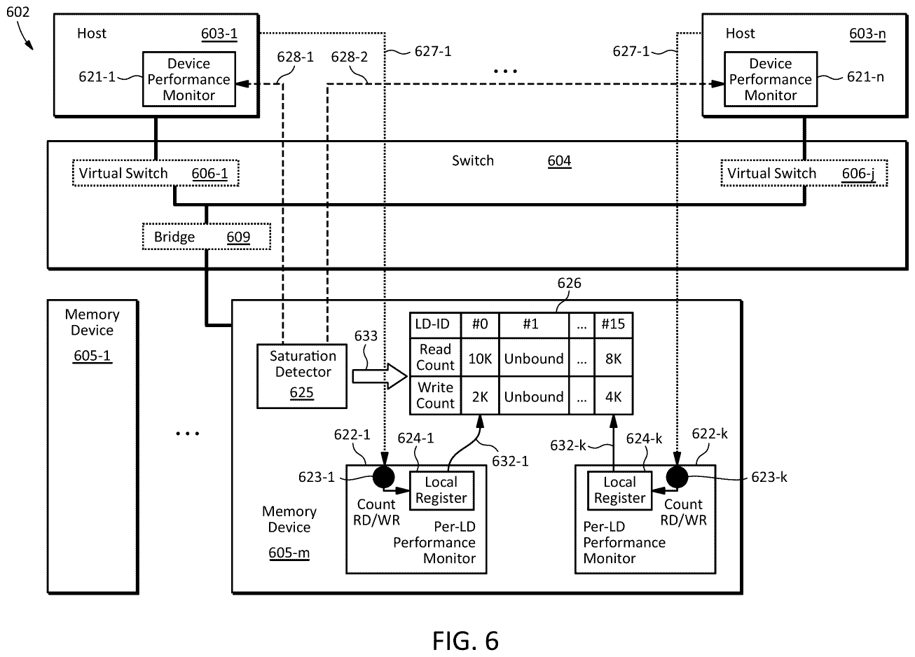

FIG. 6 illustrates an example embodiment of a method and apparatus for monitoring, detecting, and/or sending a notification of, a throughput saturation condition for a memory device in accordance with example embodiments of the disclosure. The embodiment illustrated in FIG. 6 may be implemented with, or be used to implement, any of the memory devices, memory systems, and/or operations and/or methods disclosed herein, for example, the throughput detection and/or notification operations illustrated and described with respect to FIG. 3.

In the embodiment illustrated in FIG. 6, memory system 602 may include one or more elements that may, in some aspects, be similar to the embodiments illustrated in other figures in which similar elements may be indicated by reference numbers ending in, and/or containing, the same digits, letters, and/or the like. For example, memory system 602 may include one or more hosts 603-1, . . . 603-n, a switch 604 having one or more virtual switches 606-1, . . . 606-j and/or one or more bridges 609, and/or one or more memory devices 605-1, . . . 605-m.

For purposes of illustration, in the embodiment illustrated in FIG. 6, one or more of switch 604, virtual switches 606, memory devices 605, communication links 607 and/or 608, bridges 609, and/or the like, may be described and implemented with CXL components, interconnects, interfaces, protocols, and/or the like. For example, one or more of virtual switches 606 may be implemented with VCSs, and/or one or more of memory devices 605 may be implemented with CMMs. In other embodiments, however, other memory access components, interconnects, interfaces, protocols, and/or the like, may be used.

In the example embodiment illustrated in FIG. 6, hosts 603-1 and/or 603-n may share memory capacity in memory device 605-m. Hosts 603-1 and/or 603-n may send read requests and/or write requests to memory device 605-m using, for example, a memory protocol such as CXL.mem as indicated by arrows 627.

A memory device 605 may include one or more performance monitors 622-1, . . . 622-k that may monitor memory throughput, for example, on a per logical device basis. Thus, in some embodiments, a number k of performance monitors may be equal to a number of logical devices supported by memory device 605. In some embodiments, a performance monitor 622 may monitor throughput, for example, by maintaining a count of read requests and/or a count of write requests for an associated logical device. The counts of read requests and/or write requests may be updated (e.g., reset), for example, once per epoch. In some embodiments, an epoch may be an amount of time that may have a default value (e.g., one second) and/or may be a parameter configured by a user, a host, and/or the like. A performance monitor 622 may include a counter 623 and/or a local data structure such as a register 624. Counter 623 may maintain a count of read requests and/or a count of write requests for an associated logical device, and local register 624 may store a count of read requests and/or a count of write requests, for example, for a current epoch.

A memory device 605 may also include a saturation detector 625 and/or a count register 626. Count register 626 may maintain a count of read requests and/or a count of write requests for one or more logical devices (e.g., each logical device) supported by memory device 605. In the example illustrated in FIG. 6, memory device 605 may support up to 16 logical devices, and thus, count register 626 (which may be implemented as a dedicated register for memory device 605-m) may include entries for a read count and a write count for 16 logical devices (k=16), each of which may be identified by a logical device identifier (LD-ID) #0 through #15. Count register 626 may be configured, for example, with a parameter by one or more hosts 603 to enable signaling upon detection of throughput saturation.

In some embodiments, one or more entries for each logical device may be updated, for example, at each epoch (e.g., at the end of each epoch) by transferring counts of accumulated read requests and/or write requests from local registers 624 to corresponding entries in count register 626 as shown by arrows 632. In some embodiments, tracking counts of read requests and/or write requests on a per epoch basis may be referred to, and/or characterized as, epoch-based atomic throughput tracking.

Saturation detector 625 may determine an overall throughput for memory device 605-1 based on a combination of entries in count register 626. For example, in some embodiments, saturation detector 625 may determine an overall throughput for memory device 605-1 by summing the counts of read and/or write requests as shown by arrow 633 for some or all of the logical devices in count register 626 which may contain the accumulated request counts for one full epoch. Saturation detector 625 may detect a saturation condition for memory device 605-1, for example, when the sum of counts of read and/or write requests for some or all of the logical devices exceeds a threshold value that may have a default value and/or may be configured as a parameter by a user, a host, and/or the like. In some embodiments, saturation detector 625 may check the count register 626 periodically such as once per epoch and/or at any other time interval.

Saturation detector 625 may, based on detecting a saturation condition for memory device 605-1, send (e.g., broadcast) a notification to one or more (e.g., all) of hosts 603 as indicated by arrows 628. For example, in some embodiments, saturation detector 625 may send a saturation notification by triggering an interrupt through a CXL or other protocol. Saturation detector 625 may send saturation notifications, for example, to hosts 603 that may be configured as a parameter to receive notifications.

One or more of hosts 603-1, . . . 603-n may include a device performance monitor 621-1, . . . 621-n, respectively. Based on receiving a saturation notification from a memory device 605 as indicated by arrows 628, a performance monitor 621 may read throughput information (e.g., dynamically) from the saturation detector 625 that sent the notification. For example, a host 603-1 that received a saturation notification from saturation detector 625-k may periodically check throughput to resume memory allocation. If the saturation condition persists, host 603-1 may request an assignment of a logical device from other unsaturated memory devices from memory system 602. If, however, based on periodically checking the throughput, host 603-1 determines that the memory device 605 that sent the saturation notice is no longer saturated, host 603-1 may resume allocating memory from memory device 605.

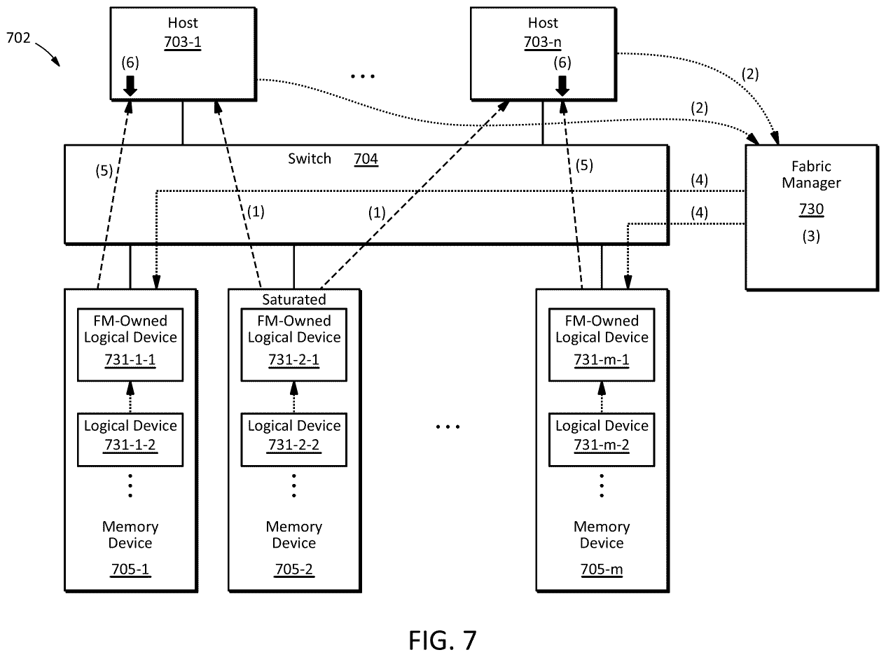

FIG. 7 illustrates an example embodiment of a method and apparatus for assigning and/or allocating a memory device and/or memory therein based on a saturation condition of a memory device in accordance with example embodiments of the disclosure. The embodiment illustrated in FIG. 7 may be implemented with, or be used to implement, any of the memory devices, memory systems, and/or operations and/or methods disclosed herein. For example, the embodiment illustrated in FIG. 7 may be used for assigning and/or allocating a memory device and/or memory therein based on a saturation notification received from the embodiment illustrated and described with respect to FIG. 6.

Referring to FIG. 7, memory system 702 may include one or more elements that may, in some aspects, be similar to the embodiments illustrated in other figures in which similar elements may be indicated by reference numbers ending in, and/or containing, the same digits, letters, and/or the like. For example, memory system 702 may include one or more hosts 703-1, . . . 703-n, a switch 704, and/or one or more memory devices 705-1, . . . 705-m.

For purposes of illustration, in the embodiment illustrated in FIG. 7, one or more of switch 704 memory devices 705, communication links, and/or the like, may be described and implemented with CXL components, interconnects, interfaces, protocols, and/or the like. For example, one or more of memory devices 705 may be implemented with CMMs. In other embodiments, however, other memory access components, interconnects, interfaces, protocols, and/or the like, may be used.

Memory system 702 may also include one or more fabric managers (FMs) 730 that may make assignment decisions for one or more memory devices 705 and/or logical devices or other memory located within a memory device 705. Fabric manager 730 may implement application logic, policy (e.g., page allocation priority policy), and/or the like, to make assignment decisions. Fabric manager 730 may be implemented, for example, with software and/or firmware running on, and/or embedded in, one or more hosts 703, switches 704, a controller (e.g., a baseboard management controller BMC), a dedicated device, and/or the like. In some embodiments, a fabric manager may assign a memory device 705 and/or a logical device to a host 703 by using a CCI to issue commands which may be carried, for example, in-band (e.g., using Memory Mapped Input/Output (MMIO)) or out-of-band (e.g., using MCTP which may support out-of-band communication including System Management Bus (SMBus), I2C, PCIe, Universal Serial Bus (USB), other types of serial links, and/or the like).

Fabric manager 730 may perform any number of the following functions: managing the statuses (e.g., assigned, available, unbound, bound (for example, using a virtual switch), and/or the like) of logical devices 731; maintaining information on saturation status of memory devices 705 based, for example, on reports received from one or more hosts 703 (e.g., during allocation of new logical devices 731); assigning one or more logical devices 731 from one or more memory devices 705 that are not saturated; and/or the like.

One or more (e.g., each) of memory devices 705 may include one or more logical devices 731. Some logical devices 731 may be controlled by fabric manager 730 and thus may be designated as FM-owned.

In the example embodiment illustrated in FIG. 7, hosts 703-1 and/or 703-n may share memory capacity in memory device 705-2. For example, logical device 731-2-1 may be assigned to host 703-1, and/or logical device 731-2-2 may be assigned to host 703-n.

At operation (1), a saturation detector in memory device 705-2 may determine that the throughput of memory device 705-2 has become saturated, for example, as explained with respect to FIG. 5 and/or FIG. 6. Thus, memory device 705-2 may send a saturation notification (e.g., by broadcasting) to hosts 703-1 and/or 703-n by using, for example, an interrupt.

At operation (2), hosts 703-1 and/or 703-n may send a request to fabric manager 730 providing information (e.g., a device identifier) on saturated memory device 705-2 and/or requesting an assignment of one or more logical devices (e.g., from a memory device 705 that is not saturated).

At operation (3), fabric manager 730 may assign one or more new logical devices 731 to host 703-1 from memory device 705-1 which may not be saturated. Fabric manager 730 may also assign one or more new logical devices 731 to host 703-n from memory device 705-m which may not be saturated.

At operation (4), fabric manager 730 may send a request to memory device 705-1 to attach to host 703-1, for example, by sending a CCI command using a mailbox technique and/or using MCTP. Fabric manager 730 may send a request to memory device 705-m to attach to host 703-n, for example, by sending a CCI command using a mailbox technique and/or using MCTP.

At operation (5), memory device 705-1 may attach to host 703-1 and/or send an interrupt to host 703-1 to indicate an assignment of a new logical device 731-1-1 to host 703-1. Memory device 705-m may attach to host 703-n and/or send an interrupt to host 703-n to indicate an assignment of a new logical device 731-m-1 to host 703-n.

At operation (6), host 703-1 may allocate one or more new pages of memory from logical device 731-1-1, and host 703-n may allocate one or more new pages of memory from logical device 731-m-1.

Depending on the implementation details, the embodiments illustrated and described with respect to FIG. 6 and/or FIG. 7 may improve memory access performance, for example, by enabling one or more logical devices at one or more memory devices that are not saturated to be assigned to one or more hosts, thereby enabling the one or more hosts to access the newly assigned logical devices with more throughput than would be available if the logical devices were assigned from a saturated memory device.

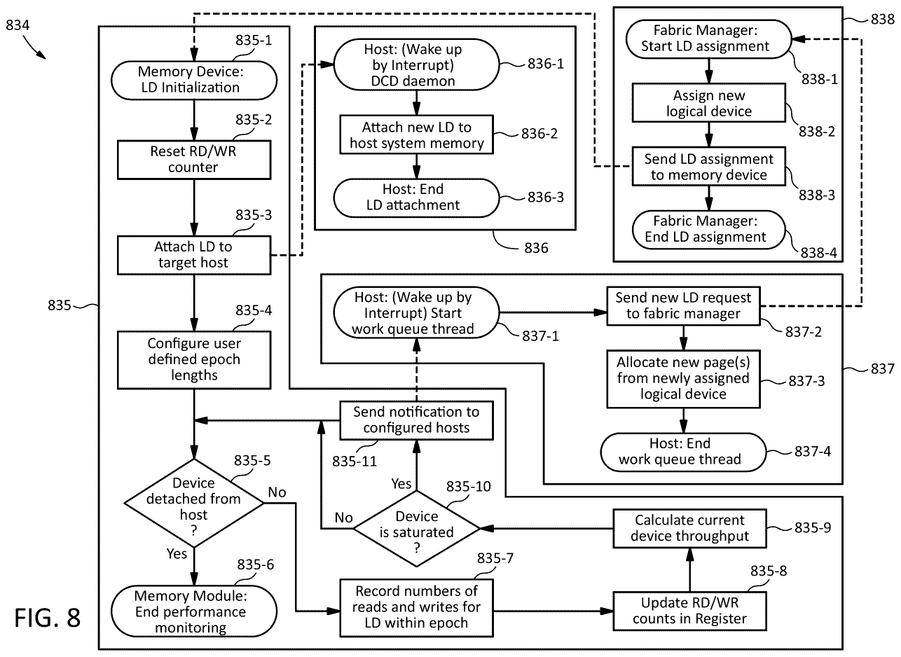

FIG. 8 illustrates an embodiment of a method for assigning memory based on a throughput of a memory device in accordance with example embodiments of the disclosure. The method 834 illustrated in FIG. 8 may be used to implement, or may be implemented with, any of the embodiments disclosed herein including, for example, the embodiments illustrated and described with respect to FIG. 6 and FIG. 7.

Referring to FIG. 8, method 834 includes a first portion 835 that may be implemented by a memory module, a second portion 836 and a third portion 837 that may be implemented by a host, and/or a fourth portion 838 that may be implemented by a fabric manager.

Portion 835 may begin at operation 835-1 in which a memory device may initialize one or more logical devices that may be attached to a host. Examples may include one or more logical devices 731 illustrated in FIG. 7.

At operation 835-2, a memory device may reset one or more read request counters and/or write request counters. Examples may include read and/or write counters 623 illustrated in FIG. 6.

At operation 835-3, a memory device may attach one or more logical devices to a target host. Examples may include one or more logical devices 731 illustrated in FIG. 7. Also at operation 835 3, a memory device may invoke a portion 836 (beginning at operation 836-1 and described below) of method 834 that may be performed by one or more hosts. The memory device may proceed to operation 835-4. Portion 836 may proceed in parallel, in sequence, or in a combination thereof, with portion 835 of method 834.

At operation 835-4, a memory device may configure one or more epoch lengths. Examples may include epoch lengths for one or more performance monitors 622, one or more registers 626, and/or one or more saturation detectors 625 illustrated in FIG. 6. In some embodiments, a default length (e.g., one second) may be used.

At operation 835-5, a memory device may determine if it is detached from any hosts such as a host 603 illustrated in FIG. 6 and/or a host 703 illustrated in FIG. 7. If the memory device is detached from any hosts, it may end any performance monitoring at operation 835-6. If, however, the memory device is still attached to at least one host, the method may proceed to operation 835-7 where it may record numbers of read requests and/or write requests, for example, on an epoch basis. Examples may include counting read and/or write requests using one or more counters 623 and/or local registers 624 illustrated in FIG. 6.

At operation 835-8 a memory device may update one or more counts of read requests and/or write requests, for example, by transferring one or more epoch-based counts from one or more local registers 624 to corresponding entries in a register (e.g., a dedicated register) 626 illustrated in FIG. 6.

At operation 835-9, a memory device may calculate its current throughput. In some example embodiments, a calculation may be performed by a saturation detector such as saturation detector 625 illustrated in FIG. 6. In some example embodiments, a calculation may be performed by summing one or more read and/or write counts (e.g., from register 626) according to the following equation (Eq. 1):

$$MemoryDeviceTP = {\sum }_{LD - ID = 0}^{k} {LogicalDeviceTP}_{LD - IP}$$

where MemoryDeviceTP may be the current overall memory device throughput, TP_{LD-ID} may be the total throughput for a specific logical device with logical device LD-ID (which may be determined, for example, by summing the read count and write count from a column corresponding to the specific LD-ID in register 626 in FIG. 6), and k may be the total number of logical devices, for example, as illustrated in FIG. 6.

At operation 835-10, a memory device may use the current overall memory device throughput calculated in operation 835-9 to determine if the memory device is saturated, for example, by comparing the current overall memory device throughput to a threshold (e.g., percentage of maximum bandwidth such as 100 percent or a lower percentage at which the memory device may be effectively saturated because it may not be able to support enough additional throughput to efficiently access another logical device or other unit of memory). If the memory device is not saturated, the method may return to operation 835-5.

If, however, the memory device determines it is saturated, the method may proceed to operation 835-11 at which the memory device may send (e.g., broadcast) one or more notifications to one or more hosts to which the memory device may be assigned, attached, and/or the like. In some embodiments, the memory device may send a notification by using an interrupt mechanism.

Also at operation 835-11, a memory device may invoke a portion 837 of method 834 (beginning at operation 837-1 and described below) that may be performed, for example, by one or more hosts to which the memory device may be assigned, attached, and/or the like. The memory device may then proceed back to operation 835-5. Portion 837 may proceed in parallel, in sequence, or in a combination thereof, with portion 835 of method 834.

Referring back to operation 836-1, a host may start a daemon for a dynamic capacity device (DCD) type of memory device to configure one or more logical devices for the host. In some embodiments, the host may start the daemon when the host is woken up by an interrupt.

At operation 836-2, a host may attach a new logical device to host system memory. In some embodiments, the host may configure an epoch length, for example, for a saturation detection operation that may be implemented, for example, by saturation detector 625, and/or one or more performance monitors 622 illustrated in FIG. 6.

At operation 836-3, the host may end the logical device attachment operation.

Referring back to operation 837-1, a host may start one or more work queue threads. In some embodiments, the host may start a work queue thread when the host is woken up by an interrupt (e.g., received from a memory device).

At operation 837-2, a host may send a request to a fabric manager to assign and/or allocate a new logical device and/or memory device. In some embodiments, the request may include information about one or more saturated memory devices (e.g., a memory device ID) to enable the fabric manager to track throughput and/or saturation statuses of one or more memory devices.

Also at operation 837-2, a host may invoke a portion 838 of method 834 (starting at operation 838-1) that may be performed by a fabric manager. The host may proceed to operation 837-3. Portion 838 may proceed in parallel, in sequence, or in a combination thereof, with portion 837 of method 834.

At operation 837-3, a host may allocate one or more pages of memory from a logical device that may have been newly assigned, attached, allocated, and/or the like.

At operation 837-4, a host may end one or more work queue threads.

Referring back to operation 838-1, a fabric manager (e.g., fabric manager 730 illustrated in FIG. 7) may start a logical device assignment process.

At operation 838-2, a fabric manager may assign one or more new logical devices to a requesting host. Examples may include one or more assignment operations (3) illustrated in FIG. 7.

At operation 838-3, a fabric manager may send a request to a memory device informing the memory device of one or more logical device assignments from operation 838-2 and requesting the memory device to attach to a target host. Examples may include one or more request operations (4) illustrated in FIG. 7.

Also at operation 838-3, a fabric manager may invoke portion 835 (which may start at operation 835-1) of method 834 that may be performed by a memory device.

At operation 838-4, a fabric manager may end a logical device assignment process.

In some embodiments, and depending on the implementation details, one or more aspects of the disclosure may provide any number of the following advantages, features, and/or the like. Some embodiments may provide an adaptive throughput scaling mechanism using a switch and/or a memory access protocol such as CXL, OpenCAPI, CCIX, DMA, RDMA, ROCE, and/or the like. Some embodiments may implement epoch-based atomic throughput tracking which, depending on the implementation details, may provide an accurate throughput monitoring technique. Some embodiments may implement a device-level throughput saturation detection system which, depending on the implementation details, may provide relatively low overhead device saturation detection and/or may require little or no inter-host communication. Some embodiments may implement a throughput saturation notification broadcasting technique. Some embodiments may implement device saturation status management in a fabric manager which, depending on the implementation details, may provide a throughput-aware logical device assignment mechanism. Some embodiments may implement a page allocation priority policy.

In some embodiments, and depending on the implementation details, one or more aspects of the disclosure may provide any number of the following advantages, features, and/or the like. Some embodiments may implement epoch-based atomic tracking of read and/or write operations for one or more logical devices (e.g., each logical device). For example, a method may atomically record read and/or write counts per logical device on an epoch basis which, depending on the implementation details, may provide precise resource monitoring. Some embodiments may implement saturation detection based on logical device read and/or write counts. For example, a saturation detector may determine device saturation by analyzing cumulative read and/or write counts of one or more (e.g., all) associated logical devices. Some embodiments may implement broadcasting saturation notifications, for example, via interrupts. In some embodiments, for example, upon detecting device saturation, the device may broadcast a notification to connected hosts using interrupts. In some embodiments, a host may request one or more new logical devices and/or provide information to identify a saturated device to a fabric manager. In some embodiments, the host may request the fabric manager to assign a new logical device from a non-saturated memory device and/or provide an ID of a saturated device. In some embodiments, a fabric manager may assign a non-saturated logical device and/or request the device to attach to a host. In some embodiments, a fabric manager may allocate a non-saturated logical device to a host and request the corresponding memory device to attach the logical device to the host. In some embodiments, a device may attach an assigned logical device to a host. The assigned device may attach the new logical device to the host for the host to use. In some embodiments, a host may allocate pages from the non-saturated logical device, and the host may allocate one or more pages from the newly attached, non-saturated logical device.

In some embodiments, a memory access switch such as a CXL switch may generally scale capacity by adding memory blocks and/or logical devices when memory utilization exceeds a set threshold. Beyond capacity scaling, however, a memory access switch may also serve as a mechanism to boost throughput. Aspects of this disclosure may provide throughput-based memory expansion mechanisms to enhance overall performance using a memory access switch.

In some shared server environments in accordance with example embodiments of the disclosure, individual servers may lack insight into the cumulative throughput (e.g., of one or more memory devices) which may involve one or more memory device providing one or more (e.g., each) host with aggregated throughput data to accurately reflect the memory device's resource status. Upon reaching throughput saturation, a new logical device may be attached to the system, and additional memory may be allocated from this logical device to extend throughput capacity.

Some aspects of this disclosure relate to throughput-based dynamic memory scaling mechanisms for memory access switch (e.g., a CXL switch), which may dynamically adjust resources based on demand across one or more memory devices. An epoch-based atomic throughput tracking method may record throughput data at specified (e.g., fixed) intervals, and a throughput monitoring technique may collect data (e.g., in real-time) which may provide accurate monitoring. In some embodiments, device-level throughput saturation detection may identify overload (e.g., saturation) conditions and/or reduce system load through relatively low-overhead saturation detection. Some embodiments may involve little or no inter-host communication which, depending on the implementation details, may reduce or minimize latency. Some embodiments may use a saturation notification broadcasting method to prompt relatively prompt (e.g., immediate) responses. In some embodiments, saturation status may be managed by a fabric manager which, depending on the implementation details, may provide improved or optimal performance. Additionally, or alternatively, a throughput-based logical assignment mechanism may allocate resources based on real-time data. Additionally, or alternatively, a page allocation priority policy may manage memory access priority which, depending on the implementation details, may reduce or minimize latency and/or increase or maximize throughput.

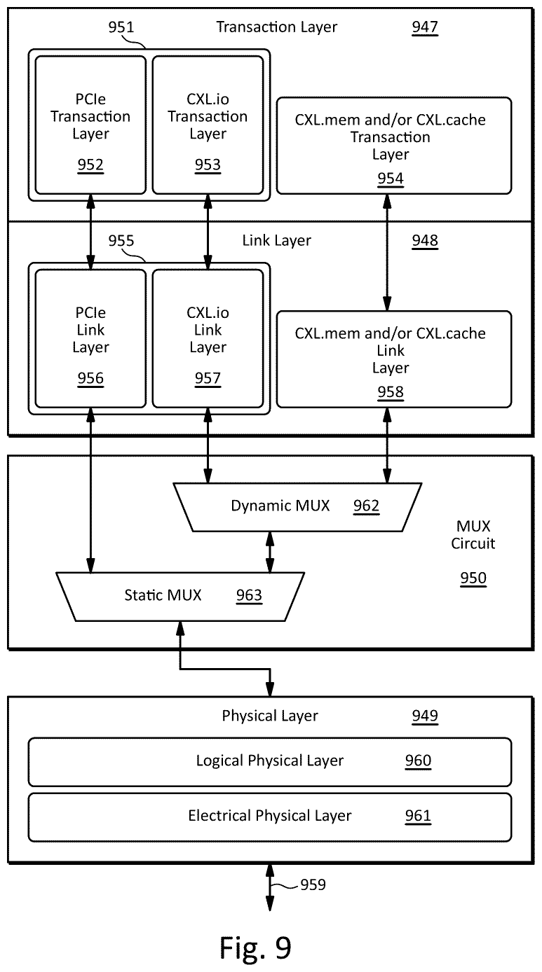

FIG. 9 illustrates an embodiment of a memory access protocol stack in accordance with example embodiments of the disclosure. The protocol stack illustrated in FIG. 9 may include a transaction layer 947, a link layer 948, a physical layer 949, and/or an arbitration and/or multiplexing and/or demultiplexing circuit 950 (which may also be referred to as a multiplexer, a MUX, an ARB/MUX circuit, a MUX circuit, and/or the like).

The transaction layer 947 may include a first portion 951 (which may be referred to as a PCIe/CXL transaction layer) that may include logic to implement a PCIe transaction layer 952 and/or a CXL.io transaction layer 953. In some embodiments, some or all of the CXL.io transaction layer 953 may be implemented as an extension, enhancement, and/or the like, of some or all of the PCIe transaction layer 952. Although shown as separate components, in some embodiments, a PCIe transaction layer 952 and CXL.io transaction layer 953 may be converged into one component. The transaction layer 947 may include a second portion 954 (which may be referred to as a CXL.mem/CXL.cache transaction layer, a CXL.cachemem transaction layer, and/or the like) that may include logic to implement a CXL.mem and/or CXL.cache transaction layer.

The transaction layer 947 may implement transaction types, transaction layer packet formatting, transaction ordering rules, and/or the like. In some embodiments, the CXL.io transaction layer 953 may be similar, for example, to a PCIe transaction layer 952. For CXL.mem, the CXL.mem/CXL.cache transaction layer 954 (which may be implemented as a second portion of the overall transaction layer 947) may implement message classes (e.g., in each direction), one or more fields associated with message classes, message class ordering rules, and/or the like. For CXL.cache, the CXL.mem/CXL.cache transaction layer 954 may implement one or more channels (e.g., in each direction) such as channels for request, response, data, and/or the like, transaction opcodes that may flow through a channel, channel ordering rules, and/or the like.

The link layer 948 may include a first portion 955 (which may be referred to as a PCIe/CXL link layer) that may include logic to implement a PCIe link layer 956 (which may also be referred to as a data link layer) and/or a CXL.io link layer 957. In some embodiments, some or all of the CXL.io link layer 957 may be implemented as an extension, enhancement, and/or the like, of some or all of the PCIe link layer 956. Although shown as separate components, in some embodiments, a PCIe link layer 956 and CXL.io link layer 957 may be converged into one component. The link layer 948 may include a second portion 958 (which may be referred to as a CXL.mem/CXL.cache link layer, a CXL.cachemem link layer, and/or the like) that may include logic to implement a CXL.mem and/or CXL.cache link layer.

The link layer 948 may implement transmission of transaction layer packets across a physical link 959 (e.g., one or more physical lanes). In some embodiments, the link layer 948 may implement one or more reliability mechanisms such as a retry mechanism, cyclical redundancy check (CRC) code calculation and/or checking, control flits, and/or the like. In some embodiments, the CXL.io link layer 957 may be similar, for example, to a PCIe link layer 956. For CXL.mem and/or CXL.cache, the CXL.mem/CXL.cache link layer 958 may implement one or more flit formats, flit packing rules (e.g., for selecting transactions from internal flit queues to fill slots), and/or the like.

The physical layer 949 (which may also be referred to as a PHY or Phy layer) may implement, operate, train, and/or the like, a physical link 959, for example, to transmit PCIe packets, CXL flits, and/or the like. The physical layer 949 may include a logical physical layer 960 (which may also be referred to as a logical PHY, logPHY, or a LogPhy layer) and/or an electrical physical layer 961 (which may also be referred to as an analog physical layer). In some embodiments, on a transmitting side of a link, the logical physical layer 960 may prepare data from a link layer for transmission across a physical link 959. On a receiving side of a link, the logical physical layer 960 may convert data received from the link to an appropriate format to pass on to the appropriate link layer. In some embodiments, the logical physical layer 960 may perform framing of flits and/or physical layer packet layout for one or more flit modes.

The electrical physical layer 961 may include one or more transmitters, receivers, and/or the like to implement one or more lanes. A transmitter may include one or more components such as one or more drivers to drive electrical signals on a channel, a deskew circuit, clock circuitry, and/or the like. A receiver may include one or more components such as one or more amplifiers and/or sampling circuits to receive data signals, clock signals, and/or the like), a deskew circuit, clock circuitry (e.g., a clock recovery circuit), and/or the like.

In some embodiments, the logical physical layer 960 may be implemented at least partially as a converged logical physical layer that may operate in a PCIe mode, a CXL mode, and/or the like, depending, for example, on an operating mode of the transaction layer 947 and/or the link layer 948.

The MUX circuit 950 may be configured to perform one or more types of arbitration, multiplexing, and/or demultiplexing (which may be referred to individually and/or collectively as multiplexing) of one or more protocols to transfer data over a physical link 959. In some embodiments, the MUX circuit 950 may include a dynamic multiplexing circuit 962 that may dynamically multiplex transfers using one or more of the CXL.io, CXL.mem, and/or CXL.cache protocols onto the physical link 959. For example, after the physical link 959 has been configured, trained, and/or the like, the dynamic multiplexing circuit 962 may interleave transactions using one or more of the CXL.io, CXL.mem, and/or CXL.cache protocols onto the physical link 959, depending on the implementation details, without reconfiguring, retraining, and/or the like, the physical link 959.

In some embodiments, the MUX circuit 950 may include a static multiplexing circuit 963 that may statically multiplex transactions using one or more of the CXL protocols (e.g., CXL.io, CXL.mem, and/or CXL.cache) with transactions using a PCIe protocol onto the physical link 959. For example, in some embodiments, the physical link 959 may be reconfigured, retrained, and/or the like, between transactions using a CXL protocol and transactions using a PCIe protocol.

The protocol stack illustrated in FIG. 9, or one or more portions thereof, may be used, for example, to implement any of the CXL techniques described in this disclosure. In some embodiments, one or more portions of the protocol stack illustrated in FIG. 9 may be omitted, and/or one or more additional portions may be included. For example, some embodiments may omit the PCIe transaction layer 952 and/or the PCIe link layer 956.

Any of the functionality described herein, including any of the host functionality, memory device functionally, one or more control circuits, fabric manager functionality, and/or the like, may be implemented with hardware, software, firmware, or any combination thereof including, for example, hardware and/or software combinational logic, sequential logic, timers, counters, registers, state machines, volatile memories such DRAM and/or static random access memory (SRAM), nonvolatile memory including flash memory, persistent memory such as cross-gridded nonvolatile memory, memory with bulk resistance change, PCM, and/or the like and/or any combination thereof, complex programmable logic devices (CPLDs), field programable gate arrays (FPGAs), application specific integrated circuits (ASICs), CPUs including CISC processors such as x86 processors and/or RISC processors such as ARM processors, GPUs, NPUs, TPUs, and/or the like, executing instructions stored in any type of memory. In some embodiments, one or more components may be implemented as a system-on-chip (SOC), a multi-chip module, one or more chiplets (e.g., integrated circuit (IC) dies) in a package, and/or the like.

Some embodiments disclosed above have been described in the context of various implementation details, but the principles of this disclosure are not limited to these or any other specific details. For example, some functionality has been described as being implemented by certain components, but in other embodiments, the functionality may be distributed between different systems and components in different locations and having various user interfaces. Certain embodiments have been described as having specific processes, operations, etc., but these terms also encompass embodiments in which a specific process, operation, etc. may be implemented with multiple processes, operations, etc., or in which multiple processes, operations, etc. may be integrated into a single process, step, etc. A reference to a component or element may refer to only a portion of the component or element. For example, a reference to a block may refer to the entire block or one or more subblocks. The use of terms such as “first” and “second” in this disclosure and the claims may only be for purposes of distinguishing the elements they modify and may not indicate any spatial or temporal order unless apparent otherwise from context. In some embodiments, a reference to an element may refer to at least a portion of the element, for example, “based on” may refer to “based at least in part on,” and/or the like. A reference to a first element may not imply the existence of a second element. The principles disclosed herein have independent utility and may be embodied individually, and not every embodiment may utilize every principle. However, the principles may also be embodied in various combinations, some of which may amplify the benefits of the individual principles in a synergistic manner. The various details and embodiments described above may be combined to produce additional embodiments according to the inventive principles of this patent disclosure.

Since the inventive principles of this patent disclosure may be modified in arrangement and detail without departing from the inventive concepts, such changes and modifications are considered to fall within the scope of the following claims.

1. An apparatus comprising:
a memory device comprising:
a memory;
a memory access interface configured to access the memory using a memory access protocol; and
at least one control circuit configured to send a notification based on a throughput of the memory device.

2. The apparatus of claim 1, wherein the at least one control circuit is configured to determine the throughput based on a count of one or more memory access operations.

3. The apparatus of claim 1, wherein the at least one control circuit is configured to determine the throughput based on a count of one or more memory access operations associated with an epoch.

4. The apparatus of claim 1, wherein the at least one control circuit is configured to determine the throughput based on:
one or more memory access operations for a first logical device; and
one or more memory access operations for a second logical device.

5. The apparatus of claim 1, wherein the at least one control circuit is configured to:
receive a parameter; and
determine the throughput based on the parameter and one or more memory access operations.

6. The apparatus of claim 5, wherein:
the at least one control circuit is configured to determine the throughput based on an epoch; and
the parameter comprises a length of the epoch.

7. The apparatus of claim 1, wherein the throughput of the memory device comprises a saturation condition.

8. A system comprising:
a first memory device having a first memory and a first memory access interface;
a second memory device having a second a memory and a second memory access interface;
a host having a third memory access interface;
a switch connected to the first memory access interface, the second memory access interface, and the third memory access interface; and
at least one control circuit configured to allocate a portion of the second memory to the host based on a throughput of the first memory device.

9. The system of claim 8, wherein the first memory access interface, the second memory access interface, and the third memory access interface are configured to use a memory access protocol.

10. The system of claim 8, wherein the first memory device is configured to send, based on the throughput of the first memory device, a notification.

11. The system of claim 8, wherein the first memory device is configured to send, using an interrupt, based on the throughput of the first memory device, a notification.

12. The system of claim 8, wherein:
the first memory device is configured to send, to the host, based on the throughput of the first memory device, a notification; and
the host is configured to request, based on the notification, a logical device.

13. The system of claim 8, wherein:
the host is configured to send, based on the throughput of the first memory device, to a fabric manager, a request for to assign a logical device; and
the fabric manager is configured to send, based on the request, to the host, an assignment of the logical device.

14. The system of claim 8, wherein:
the at least one control circuit is configured to send, to the host, based on the throughput of the first memory device, an assignment of a logical device; and
the second memory device is configured to attach, based on the assignment, to the host.

15. The system of claim 8, wherein:
the second memory device is configured to perform at least one operation comprising attaching, based on the throughput of the first memory device, to the host; and
the host is configured to allocate, based on the attaching, memory from the second memory device.

16. The system of claim 8, wherein the first memory device is configured to:
receive a parameter associated with the throughput of the first memory device; and
determine, based on the parameter, the throughput of the first memory device.

17. A method comprising:
detecting, at a first memory device, a throughput of the first memory device;
sending, from the first memory device, using a memory access interface, based on the detecting, a notification; and
assigning, to a host, based on the notification, a second memory device.

18. The method of claim 17, further comprising attaching, to the host, based on the notification, using a switch, the second memory device.

19. The method of claim 17, further comprising allocating, by the host, based on the assigning, memory from the second memory device.

20. The method of claim 17, further comprising selecting, based on the notification, the second memory device.
